(19) United States
(12) Patent Application Publication
(10) Pub. No.: US 2008/0129782 A1
(43) Pub. Date: Jun. 5, 2008

(54) ELEMENT SUBSTRATE, PRINTHEAD, HEAD CARTRIDGE, AND PRINTING APPARATUS

(75) Inventors: Kousuke Kubo, Yokohama-shi (JP); Yoshiyuki Imanaka, Kawasaki-shi (JP); Takuya Hatsui, Tokyo (JP); Souta Takeuchi, Yokohama-shi (JP); Takaaki Yamaguchi, Yokohama-shi (JP); Takahiro Matsui, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/947,282

(22) Filed: Nov. 29, 2007

(30) Foreign Application Priority Data
Dec. 4, 2006 (JP) 2006-327626

(51) Int. Cl. B41J 2/14; B41J 2/05

(52) U.S. Cl. 347/50; 347/57

(57) ABSTRACT

This element substrate is an element substrate for a printhead which includes a plurality of printing elements to which a first voltage is applied, a plurality of driving elements which drive the plurality of printing elements, a logical circuit which outputs a driving signal to control the plurality of driving elements, and a driving voltage converter circuit which converts the voltage of the driving signal output from the logical circuit into a second voltage lower than the first voltage and outputs the second voltage to the plurality of driving elements. The element substrate includes a driving voltage generating circuit which generates, on the basis of the first voltage, the second voltage to drive the driving voltage converter circuit. The driving voltage generating circuit has a constant current source for generating a constant current based on the first voltage and generates the second voltage based on the constant current.

### BACKGROUND OF THE INVENTION

1. Field of the Invention

The present invention relates to a printhead element substrate having a driving voltage generating circuit for driving a driving voltage converter circuit, a printhead, a head cartridge, and a printing apparatus.

2. Description of the Related Art

FIG. 2 shows the circuit arrangement of a conventional inkjet printhead. In a printhead of this type, the electrothermal transducers (heaters) and their driving circuits can be formed on a single substrate by using a semiconductor process technique, as described in, e.g., U.S. Pat. No. 6,290,334.

Referring to FIG. 2, electrothermal transducers (heaters) 101 generate heat to discharge ink. N-type power transistors 102 supply a desired current to the heaters 101. A shift register 106 temporarily stores image data which determines whether to supply a current to the heaters 101 and discharge ink from the nozzles of the printhead. The shift register 106 has a transfer clock signal input terminal (CLK) and an image data input terminal (DATA) for serially receiving image data to turn on/off the heaters 101. A latch circuit 105 stores and holds image data for a corresponding one of the heaters 101. Each latch circuit 105 which receives a signal output from the shift register 106 has a latch signal input terminal (LT) for receiving a latch signal to control the latch timing. An AND circuit 104 receives a signal output from a corresponding latch circuit 105 and a heat enable signal (HE) which determines the timing to let a current flow to the heater 101. A driving signal output from the AND circuit 104 passes through a driving voltage converter circuit 103 and enters the gate of the power transistor 102 serving as a driving element that performs switching to selectively direct a current flow to the heater. The power transistor 102 is a field effect transistor such as an NMOS transistor or n-type DMOS (diffusion MOS) transistor.

The circuit arrangement of the driving voltage converter circuit 103 will be described. A first inverter circuit 208 inverts the driving signal from the AND circuit 104. A second inverter circuit 207 further inverts the signal output from the first inverter circuit 208. A PMOS transistor 202 and NMOS transistor 203 constitute a first CMOS inverter circuit. A first buffer PMOS transistor 201 divides a voltage VHTM which is output from a driving voltage generating circuit 107 for generating the driving voltage of the power transistor and applied to the internal power supply line so as to drive the first CMOS inverter circuit at the voltage (generally 5 V or less) of the signal output from the AND circuit 104. A PMOS transistor 205 and NMOS transistor 206 constitute a second CMOS inverter circuit. Reference numeral 204 denotes a second buffer PMOS transistor. The gate of the second buffer PMOS transistor 204 is connected to the connection portion between the PMOS transistor 202 and the NMOS transistor 203, i.e., the output portion of the first CMOS inverter circuit. The gate of the first buffer PMOS transistor 201 is also connected to the connection portion between the PMOS transistor 205 and the NMOS transistor 206, i.e., the output portion of the second CMOS inverter circuit. This connection portion also serves as the output portion of the driving voltage converter circuit.

The voltage VHTM output from the driving voltage generating circuit 107 is preferably set as high as possible without exceeding the breakdown voltage of the. CMOS inverters and the gate breakdown voltage of the MOS transistors. Normally, a voltage (heater driving voltage) VH to drive the heaters is often set to a high voltage of 20 V or more. The breakdown voltage of the CMOS inverters is often about 15 V or less. The gate breakdown voltage of the MOS transistors depends on their gate oxide film. The gate breakdown voltage must therefore be much lower than the insulating breakdown voltage of the gate oxide film.

That is, it is difficult to make the voltage output from the driving voltage converter circuit match the driving voltage of the heaters. On the other hand, when the power supply line for the voltage output from the driving voltage converter circuit is provided separately from the heater power supply voltage line, the cost of the entire system rises.

FIG. 3 shows the circuit arrangement of the driving voltage generating circuit 107 (Japanese Patent Publication Laid-Open No. 11-129479). An arbitrary voltage is generated from the heater driving voltage VH in accordance with the voltage division ratio of resistors R0 and R1. A source follower circuit including a resistor R2 and an NMOS transistor T1 serving as a buffer is connected to the voltage. The source of the NNOS transistor T1 serves as the output terminal of the driving voltage generating circuit 107. FIG. 4 is a timing chart of various signals to drive the printhead driving circuit shown in FIG. 2. The printhead driving circuit shown in FIG. 2 will be described with reference to FIG. 4.

A transfer clock signal (CLK) and image data (DATA) are input to the shift register. The shift register 106 operates in synchronism with the leading edge of the transfer clock signal (CLK). The number of bits of the image data (DATA) stored in the shift register 106 equals the number of heaters 101 and the number of power transistors 102. Hence, after the image data (DATA) and the pulses of the transfer clock signal (CLK) equal in number to the heaters are input to the shift register 106, a latch signal (LT) is input. The latch circuits 105 hold the image data (DATA) corresponding to the heaters 101. Then, each AND circuit 104 calculates the logical product between the heat enable signal (HE) and the signal output from a corresponding latch circuit. A current flows from the heater power supply line to the power transistor 102 and heater 101 during only a time corresponding to the driving signal output from the AND circuit 104. The current flows to the GNDH line. At this time, the heater 101 generates heat necessary for discharging ink so that the nozzle of the printhead discharges ink corresponding to the image data.

However, the driving voltage generating circuit of the prior art determines the output voltage VHTM in accordance with the voltage division ratio of the resistors and therefore has the following problems.

### The First Problem is as Follows

The voltage VHTM output from the driving voltage generating circuit, which is higher than the operating voltage of the logical circuit such as the shift register or latch circuit and lower than the heater driving voltage (VH), is generated on the basis of the heater driving voltage VH. Hence, the voltage VHTM largely depends on the variation in voltage VH. The variation in voltage VH varies the voltage VHTM. The variation in voltage VHTM changes the resistance (ON resistance) in turning on the power transistor 102. For this reason, it may be impossible to obtain desired discharge energy.

To obtain desired discharge energy, generally, thermal energy generated by the heater is adjusted by changing the voltage VH. However, in the printhead using the conventional driving voltage generating circuit, when the heater driving voltage (VH) changes, the voltage VHTM also changes. It is therefore impossible to employ the adjustment by changing the voltage VH.

### The Second Problem is as Follows

The voltage VHTM output from the driving voltage generating circuit depends on only the heater driving voltage (VH) and is independent from the power supply of the logical circuits. If the power supply of the logical circuits causes a fault during, e.g., attachment/detachment or use of the printhead, the logical circuits may be unable to execute a normal operation. For this reason, if the power supply of the logical circuits causes a fault when the voltage VH is being applied, the printhead may cause an operation error.

### SUMMARY OF THE INVENTION

The present invention is directed to an element substrate, printhead, head cartridge, and printing apparatus.

It is an object of the present invention to provide a printhead element substrate which does not depend on a variation in heater driving voltage and can change the heater driving voltage without redesigning a printhead. It is another object of the present invention to provide a printhead element substrate which can prevent a printhead from breaking even when abnormality occurs in the power supply of a logical circuit.

According to one aspect of the present invention, preferably, there is provided an element substrate for a printhead which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements, comprising:

a driving voltage generating circuit which generates, on the basis of the first voltage, the second voltage to drive the driving voltage converter circuit,

wherein the driving voltage generating circuit has a constant current source for generating a constant current based on the first voltage and generates the second voltage based on the constant current.

According to another aspect of the present invention, preferably, there is provided a printhead comprising an element substrate which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements,

the element substrate comprising:

a driving voltage generating circuit which generates, on the basis of the first voltage, the second voltage to drive the driving voltage converter circuit,

wherein the driving voltage generating circuit has a constant current source for generating a constant current based on the first voltage and generates the second voltage based on the constant current.

According to still another aspect of the present invention, preferably, there is provided a head cartridge having an ink tank containing ink and a printhead comprising an element substrate which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements,

the element substrate comprising:

a driving voltage generating circuit which generates, on the basis of the first voltage, the second voltage to drive the driving voltage converter circuit,

wherein the driving voltage generating circuit has a constant current source for generating a constant current based on the first voltage and generates the second voltage based on the constant current.

According to still another aspect of the present invention, preferably, there is provided a printing apparatus having a printhead comprising an element substrate which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements,

the element substrate comprising:

a driving voltage generating circuit which generates, on the basis of the first voltage, the second voltage to drive the driving voltage converter circuit,

wherein the driving voltage generating circuit has a constant current source for generating a constant current based on the first voltage and generates the second voltage based on the constant current.

The invention is particularly advantageous since it is possible to provide a printhead element substrate which does not depend on a variation in heater driving voltage and can change the heater driving voltage without redesigning a printhead.

Further features of the present invention will become apparent from the following description of exemplary embodiments (with reference to the attached drawings).

### BRIEF DESCRIPTION OF THE DRAWINGS

FIG. 1 is a circuit diagram showing the arrangement of a driving voltage generating circuit according to an embodiment of the present invention;

FIG. 2 is a circuit diagram showing the circuit arrangement of a printhead attached to a conventional inkjet printing apparatus;

FIG. 3 is a circuit diagram showing the arrangement of a conventional driving voltage generating circuit;

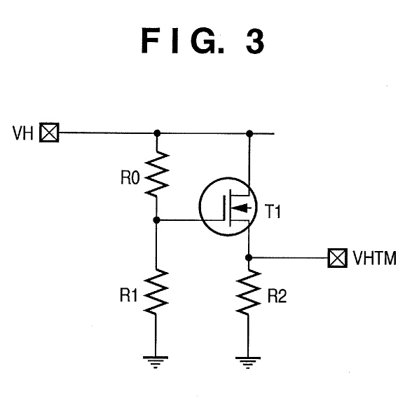

FIG. 4 is a timing chart of various signals to drive a printhead driving circuit;

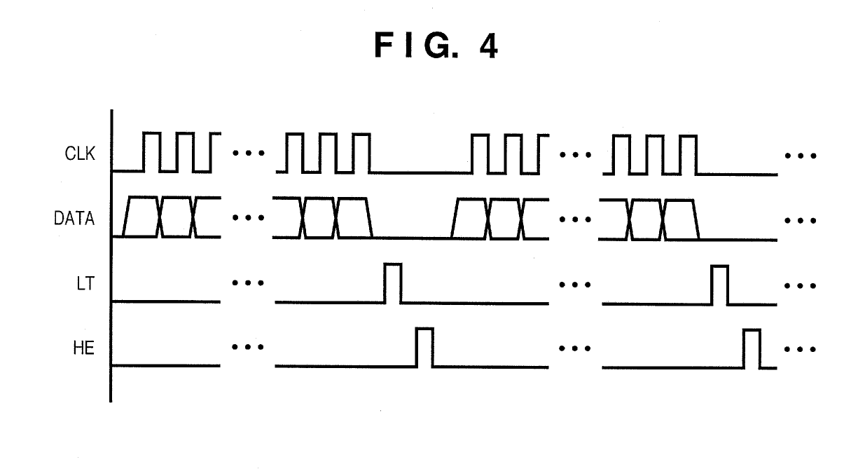

FIGS. 5A and 5B are perspective views for explaining a first printhead according to an embodiment of the present invention;

FIG. 6 is an exploded perspective view showing the first printhead according to an embodiment of the present invention;

FIG. 7 is a partially cutaway perspective view showing a first element substrate included in the first printhead according to an embodiment of the present invention;

FIG. 8 is a schematic view showing an example of the inkjet printing apparatus according to the present invention; and

FIG. 9 is a block diagram showing the control arrangement of the inkjet printing apparatus according to the present invention.

### DESCRIPTION OF THE EMBODIMENTS

An embodiment of the present invention will be described next with reference to the accompanying drawings.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be extensively interpreted similar to the definition of “print” described above. That is, “ink” includes a liquid which, when applied onto a print medium, can form images, figures, patterns, and the like, can process the print medium, and can process ink (e.g., can solidify or insolubilize a coloring agent contained in ink applied to the print medium).

An “element substrate” in the description indicates not a simple substrate made of a silicon semiconductor but a substrate with elements and wirings.

The expression “on an element substrate” indicates not only “on the surface of an element substrate” but also “inside of an element substrate near its surface”. The term “built-in” in the present invention indicates not “simply arrange separate elements on a substrate” but “integrally form and manufacture elements on an element substrate in a semiconductor circuit manufacturing process”.

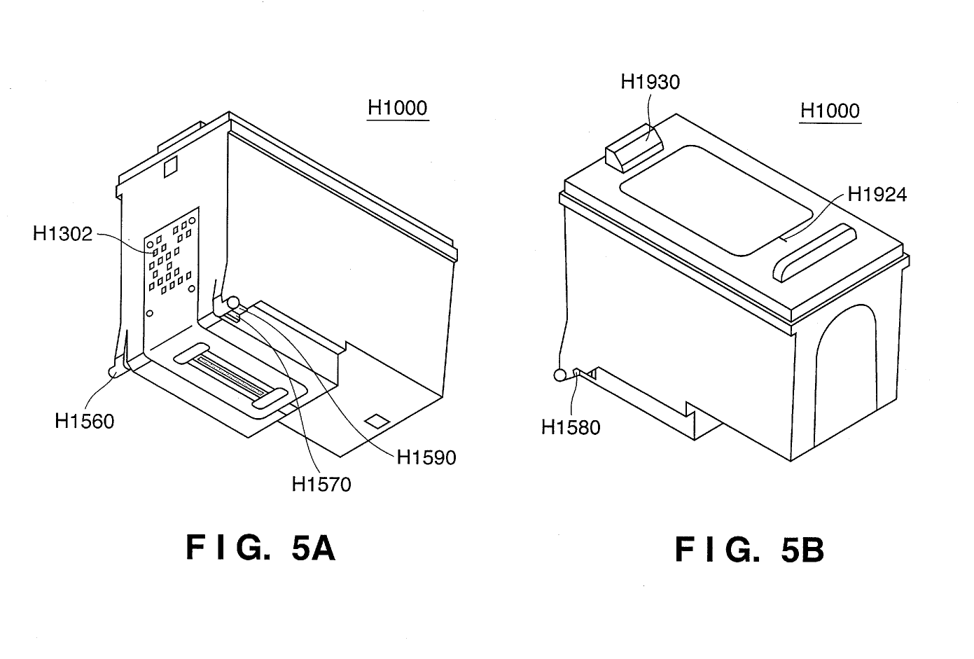

FIGS. 5A to 7 are views for explaining a suitable printhead (head cartridge) which uses or practices the present invention. The configuration elements will be described below with reference to these drawings.

The printhead of this embodiment is of an ink-tank-integrated type which contains ink. The printhead includes a first printhead H1000 filled with black ink, as shown in FIGS. 5A and 5B, and a second printhead H1001 filled with color inks (cyan ink, magenta ink, and yellow ink). These printheads H1000 and H1001 are fixed and supported on a carriage in an inkjet printing apparatus through a positioning unit and electrical contacts. The printheads are detachable from the carriage. Each printhead is exchangeable when the ink in it is consumed.

The configuration elements of the printheads H1000 and H1001 will be described below in detail.

(Printhead)

The first printhead H1000 and second printhead H1001 are bubble-jet® printheads using electrothermal transducers which generate thermal energy to cause film boiling in ink in accordance with an electrical signal. They are so-called side-shooter printheads including electrothermal transducers opposing orifices.

(1-1) First Printhead H1000

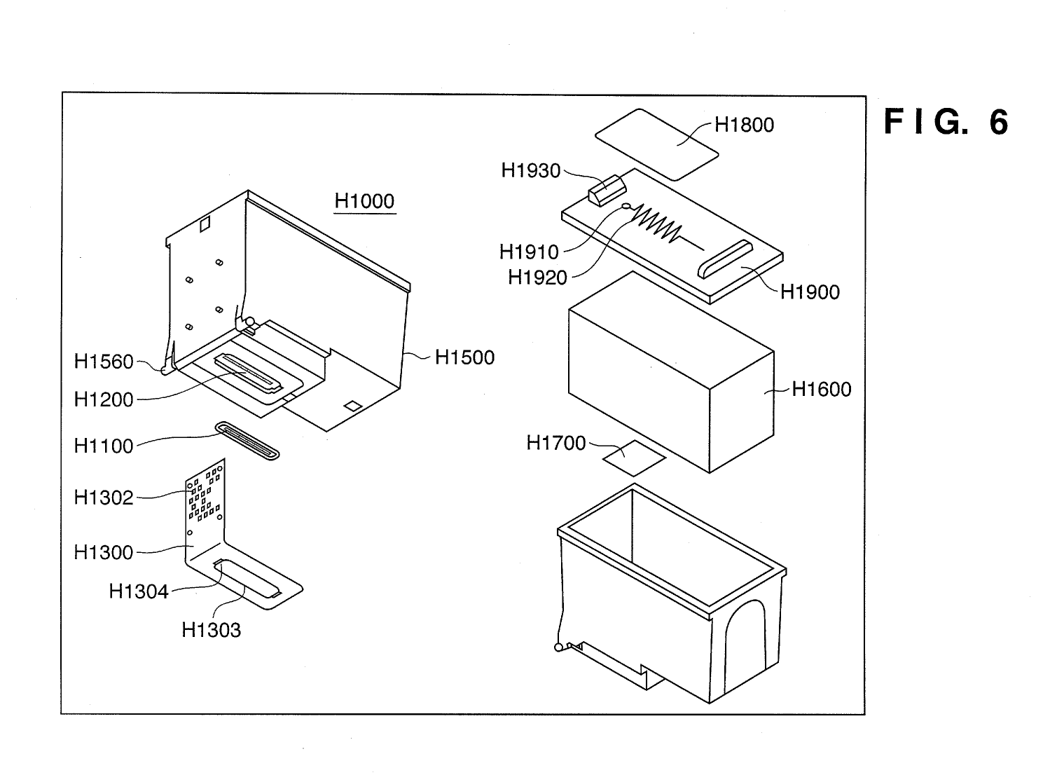

FIG. 6 is an exploded perspective view of the first printhead H1000. The first printhead H1000 includes a first printing element substrate H1100, electrical wiring tape H1300, ink supply holding member H1500, filter H1700, ink absorber H1600, lid member H1900, and seal member H1800.

(1-1-1) First Printing Element Substrate H1100

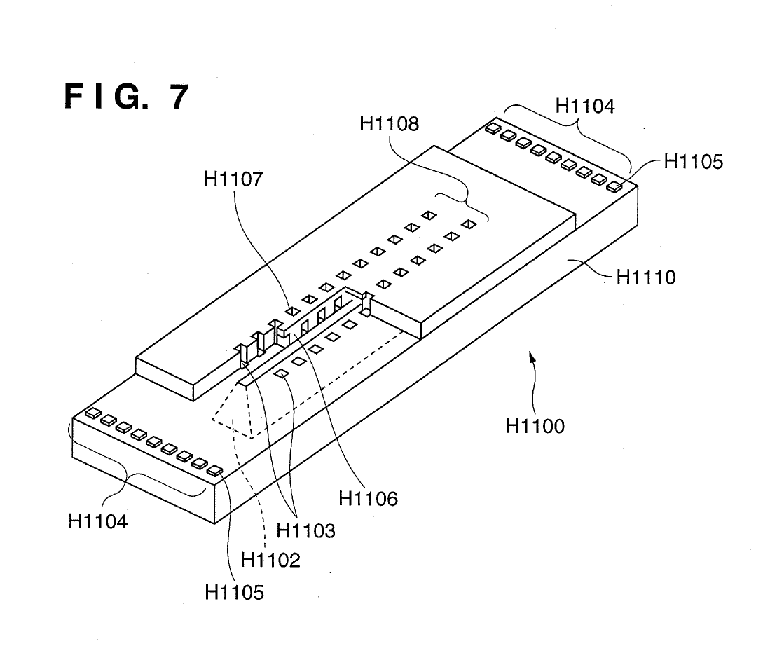

FIG. 7 is a partially cutaway perspective view for explaining the first printing element substrate H1100. The first printing element substrate H1100 is prepared by, e.g., forming, in a 0.5 to 1 mm thick Si substrate H1110, an ink supply port H1102 as a long-groove-shaped through hole serving as an ink channel by anisotropic etching using the crystal orientation of Si or sandblast.

The Si substrate H1110 has an array of electrothermal transducers H1103 serving as printing elements and an array of driving elements (not shown) to drive them on each side of the ink supply port H1102. The Si substrate H1110 also has electrical wirings (not shown) which are made of, e.g., Al and supply power to the electrothermal transducers H1103. The electrothermal transducers H1103 and electrical wirings can be formed using an existing film formation technique. The electrothermal transducers H1103 of the two arrays are staggered with each other. That is, the orifices of the two arrays are slightly shifted from each other not to stand in a line perpendicular to the array direction.

The Si substrate H1110 also has electrode portions H1104 which supply power to the electrical wirings or an electrical signal to drive the electrothermal transducers H1103. The electrode portions H1104 are arranged along sides located at both ends of each array of the electrothermal transducers H1103. Bumps H1105 made of, e.g., Au are formed on each electrode portion H1104.

A structure which is made of a resin and has an ink channel corresponding to each electrothermal transducer H1103 is formed by photolithography on the surface of the Si substrate H1110 with a pattern of memory elements such as wirings and resistive elements. This structure has ink channel walls H1106 which partition the ink channel, and a ceiling portion which covers the ink channel. Orifices H1107 are formed in the ceiling portion. The orifices H1107 oppose the electrothermal transducers H1103, respectively, thereby forming an orifice group H1108.

In the Si substrate H1110 having the above-described structure, ink is supplied from the ink supply port H1102 and discharged from the orifices H1107 opposing the electrothermal transducers H1103 by the pressure of bubbles produced by heat generated by the electrothermal transducers H1103.

(1-1-2) Electrical Wiring Tape H1300

The electrical wiring tape H1300 forms an electrical signal path to apply, to the first printing element substrate H1100, an electrical signal to discharge ink. The electrical wiring tape H1300 is obtained by forming a wiring pattern of copper foil on a base material of polyimide. The electrical wiring tape H1300 has an opening portion H1303 to fit the first printing element substrate H1100. Electrode terminals H1304 to be connected to the electrode portions H1104 of the first printing element substrate H1100 are formed near the edge of the opening portion. The electrical wiring tape H1300 also has external signal input terminals H1302 to receive an electrical signal from the main body apparatus. The external signal input terminals H1302 and electrode terminals H1304 are connected by a continuous wiring pattern of copper foil.

The electrical connection between the electrical wiring tape H1300 and the first printing element substrate H1100 is ensured by electrically joining the bumps H1105 of the first printing element substrate H1100 to the electrode terminals H1304 of the electrical wiring tape H1300 by ultrasonic thermocompression bonding.

(1-1-3) Ink Supply Holding Member H1500

As shown in FIG. 6, the ink supply holding member H1500 having the ink absorber H1600 for holding ink inside and generating a negative pressure has a function of an ink tank. The ink supply holding member H1500 which forms an ink channel to guide the ink to the first printing element substrate H1100 also has an ink supply function.

The filter H1700 for preventing dust invasion into the first printing element substrate H1100 is welded to the boundary portion between the ink channel and the portion where the ink from the ink absorber H1600 located upstream of the ink channel is supplied.

An ink supply port H1200 for supplying black ink to the first printing element substrate H1100 is formed downstream of the ink channel. To make the ink supply port H1102 of the first printing element substrate H1100 communicate with the ink supply port H1200 of the ink supply holding member H1500, the first printing element substrate H1100 is accurately bonded and fixed to the ink supply holding member H1500.

The flat surface around the bonded surface of the first printing element substrate H1100 and part of the lower surface of the electrical wiring tape H1300 are bonded and fixed by an adhesive. The reverse side of the connection portion between the electrode terminals H1302 of the electrical wiring tape H1300 and the bumps H1105 of the first printing element substrate H1100, and the outer peripheral portion of the first printing element substrate H1100 are sealed. The unbonded portion of the electrical wiring tape H1300 is bent and fixed by, e.g., bonding to a side surface of the ink supply holding member H1500, which is almost perpendicular to the bonded surface of the first printing element substrate H1100.

(1-1-4) Lid Member H1900

The lid member H1900 is welded to the upper opening portion of the ink supply holding member H1500 to hermetically seal the ink supply holding member H1500. The lid member H1900 has a narrow port H1910 to relieve a pressure variation in the ink supply holding member H1500 and a small groove H1920 communicating with the narrow port H1910. The seal member H1800 covers most of the narrow port H1910 and small groove H1920 except one end of the small groove H1920 so that an air communicating port H1924 is formed. The lid member H1900 has an engaging portion H1930 to fix the first printhead to the inkjet printing apparatus.

(1-2) Second Printhead H1001

The second printhead H1001 discharges three color inks: cyan, magenta, and yellow inks.

Attachment of the above-described printheads to the inkjet printing apparatus will be described next in detail.

As shown in FIG. 5A, the first printhead H1000 has an attachment guide H1560 to guide the printhead to the attachment position of the carriage of the inkjet printing apparatus main body. The first printhead H1000 also has the engaging portion H1930 to fix the printhead to the carriage by a head set lever. The first printhead H1000 also has a butt portion H1570 in the carriage scanning direction, a butt portion H1580 in the print medium conveyance direction, and a butt portion H1590 in the ink discharge direction to position the printhead to a predetermined attachment position of the carriage. Positioning by these butt portions enables to accurately bring the external signal input terminals H1302 on the electrical wiring tape H1300 into electrical contact with the contact pins of an electrical connection portion provided in the carriage. The second printhead H1001 is attached in the same way as the first printhead H1000.

<Inkjet Printing Apparatus>

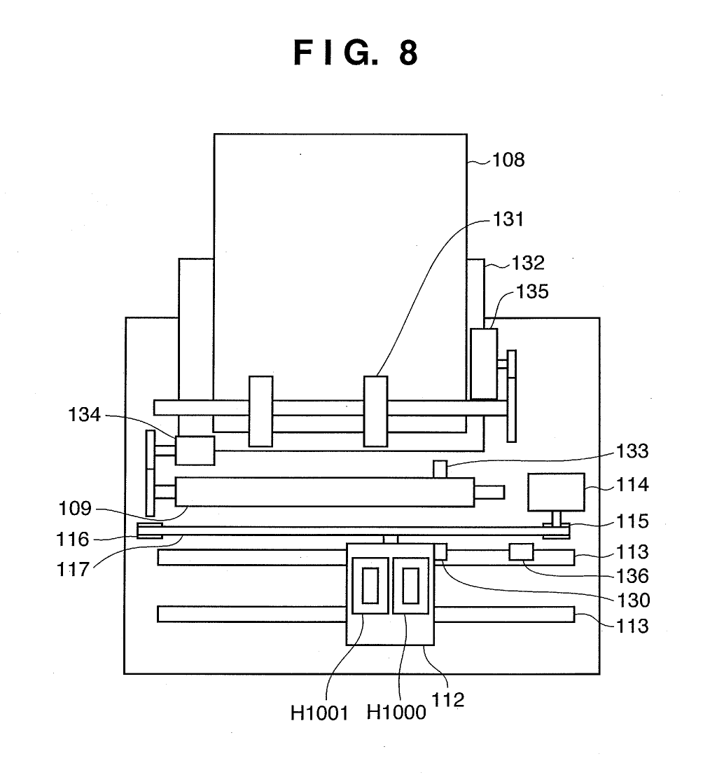

A liquid discharge printing apparatus capable of incorporating the above-described cartridge type printhead will be described next. FIG. 8 is an explanatory view showing an example of a printing apparatus capable of incorporating the inkjet printhead according to the present invention.

Referring to FIG. 8, the printing apparatus has a carriage 112 to which the first printhead H1000 shown in FIGS. 5A and 5B and the second printhead H1001 are positioned and attached exchangeably. The carriage 112 has an electrical connection portion to transmit signals and the like to the discharge units through the external signal input terminals on the printheads H1000 and H1001.

The carriage 112 is supported to be reciprocally movable along guide shafts 113 that are installed in the apparatus main body and run in the scanning direction. Driving of the carriage 112 and its position and movement control ate executed by a scanning motor 114 through a driving mechanism including a motor pulley 115, idler pulley 116, and timing belt 117. The carriage 112 has a home position sensor 130. A position regarded as the home position is detected when the home position sensor 130 on the carriage 112 passes through the position of a shield plate 136.

As a feed motor 135 rotates pickup rollers 131 through gears, a print medium 108 such as print paper or a thin plastic plate is separated from an auto sheet feeder (ASF) 132 one by one and fed. The print medium 108 is conveyed through a position (print unit) opposing the orifice surfaces of the printheads H1000 and H1001 as a conveyance roller 109 rotates. Drive of an LF motor 134 is transmitted to the conveyance roller 109 through gears. Determination of the presence/absence of print medium feed and the sheet top detecting position is done when the print medium 108 passes through a paper end sensor 133. The paper end sensor 133 is also used to detect the actual location of the trailing edge of the print medium 108 and finally specify the current print position on the basis of the actual trailing edge position.

A platen (not shown) supports the reverse surface of the print medium 108 to form a flat print surface in the print unit. In this case, the printheads H1000 and H1001 attached to the carriage 112 are held while making their orifice surfaces project downward from the carriage 112 and parallel to the print medium 108 between the two sets of conveyance roller pairs.

The printheads H1000 and H1001 are attached to the carriage 112 while making the orifice array direction of each discharge unit perpendicular to the scanning direction of the carriage 112. The orifice arrays discharge a liquid to print.

When a printhead having the same structure as the printhead H1001 and containing light magenta, light cyan, and black inks is used in place of the printhead H1000, the printing apparatus can serve as a high-quality photo-printer.

<Control Arrangement>

A control arrangement for executing print control of the above-described inkjet printing apparatus will be described next.

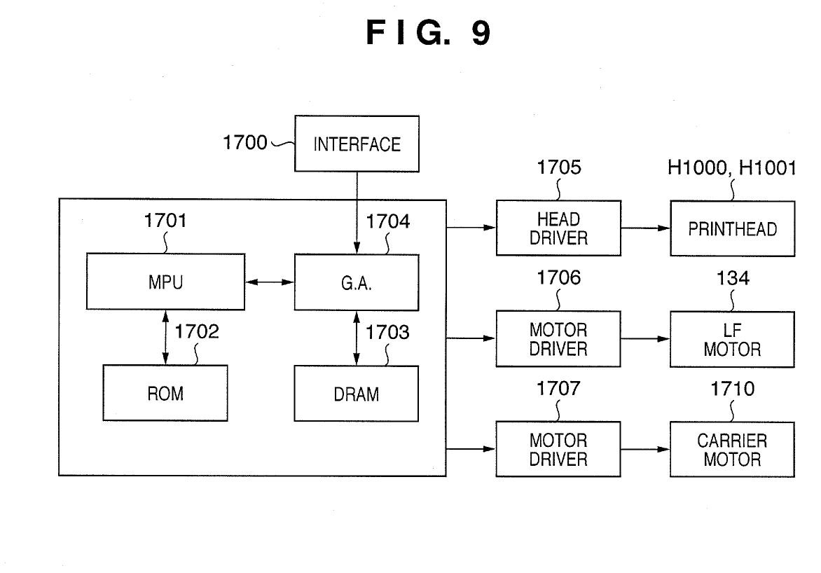

FIG. 9 is a block diagram showing the arrangement of the control circuit of the inkjet printing apparatus.

Referring to FIG. 9, reference numeral 1700 denotes an interface that inputs a print signal; 1701, an MPU; 1702, a R0M that stores a control program to be executed by the MPU 1701; and 1703, a DRAM that saves various kinds of data (e.g., the print signal and print data to be supplied to the printheads H1000 and H1001). A gate array (G.A.) 1704 controls print data supply to the printheads H1000 and H1001 and data transfer between the interface 1700, MPU 1701, and RAM 1703. A carrier motor 1710 conveys the printheads H1000 and H1001. The LF motor 134 conveys a print medium. A head driver 1705 drives the printheads H1000 and H1001. A motor driver 1706 drives the LF motor 134. A motor driver 1707 drives the carrier motor 1710.

The operation of the control arrangement will be described. When a print signal is input to the interface 1700, the print signal is converted into print data for printing between the gate array 1704 and the MPU 1701. The motor drivers 1706 and 1707 are driven. In addition, the printheads H1000 and H1001 are driven in accordance with the print data sent to the head driver 1705 so that printing is executed.

The main parts of the present invention will be described below with reference to the accompanying drawings.

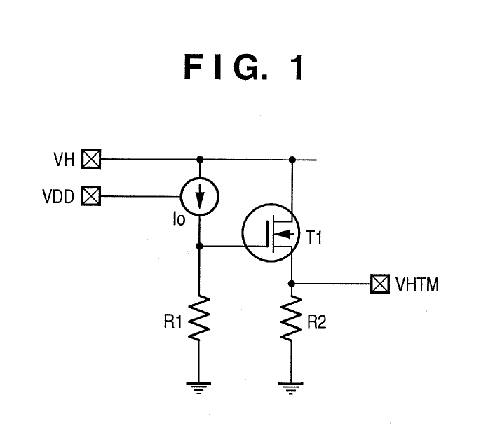

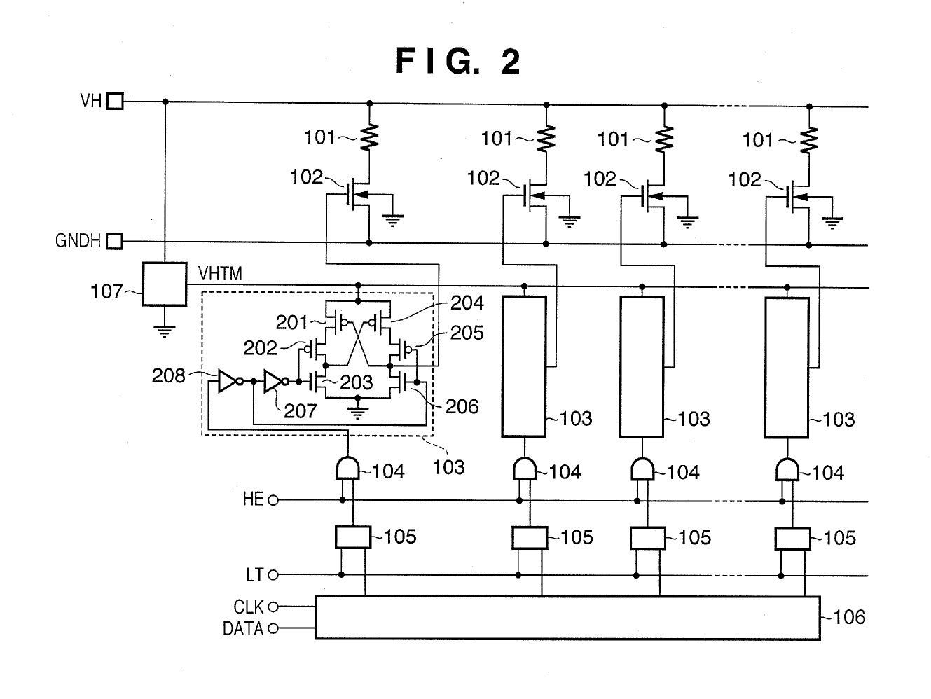

FIG. 1 shows an embodiment of the present invention. FIG. 1 is an equivalent circuit diagram showing the arrangement of a driving voltage generating circuit 107 in a driving circuit which drives the conventional printhead shown in FIG. 2. The components except the driving voltage generating circuit 107 are the same as in the prior art, and a detailed description thereof will be omitted.

The driving voltage generating circuit for generating a voltage to drive a driving voltage converter circuit has the following arrangement.

A first resistor R1 has one terminal connected to the GND potential and the other terminal connected to a constant current source Io. A voltage generated at the connection point between the first resistor R1 and the constant current source is input to the gate of an n-type field effect transistor (e.g., NMOS transistor) T1. The other terminal of the constant current source Io and the drain of the transistor T1 are connected to the power supply line of a voltage VH as a first voltage to drive heaters. The source of the transistor T1 is connected to a second resistor R2. The connection point between them serves as the output terminal of the driving voltage generating circuit 107. The other terminal of the second resistor R2 is connected to the GND potential. A voltage VHTM serving as a second voltage output from the driving voltage generating circuit 107 is applied to a driving voltage converter circuit 103 as an internal power supply line of the printhead, as in the prior art. The second voltage is obtained by dropping the first voltage by voltage division. In this arrangement, a logical circuit power supply voltage (VDD), i.e., a third voltage lower than the second voltage is used as the power supply of the constant current source Io. Hence, if the power supply voltage VDD is not normally supplied due to some reason, no constant current flows to the driving voltage generating circuit 107. The voltage VHTM output from the driving voltage generating circuit 107 is 0, and the switching element to control the printing element is turned off. This prevents any abnormal current from flowing to the printing element and increases the reliability of the printhead.

The logical circuit power supply voltage is a power supply voltage to operate logical circuits such as the above-described shift register, latch circuit, and AND circuit.

Since the constant current source Io is connected to the gate of the NMOS transistor T1, the voltage VHTM output from the driving voltage generating circuit 107 does not depend on the heater driving voltage VH. Additionally, since the constant current source Io is connected to the gate of the NMOS transistor T1, the voltage VHTM does not change even when the heater driving voltage VH to drive the heaters changes. This allows to change the voltage VH without redesigning the printhead.

The printing apparatus according to the present invention may take not only the form of an integrated or separate image output terminal of an information processing device such as a computer but also the form of a copying apparatus combined with a reader or the like, or the form of a facsimile apparatus having a transmission and reception function.

The above embodiment has been described by exemplifying an element substrate for an inkjet printhead. However, the embodiment is also applicable to an element substrate for a printhead using a thermal transfer method or a printhead of sublimation type.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-327626, filed Dec. 4, 2006, which is hereby incorporated by reference herein in its entirety.

What is claimed is:

1. An element substrate for a printhead which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements, comprising:
a driving voltage generating circuit which generates, on the basis of the first voltage, the second voltage to drive the driving voltage converter circuit,
wherein said driving voltage generating circuit has a constant current source for generating a constant current based on the first voltage and generates the second voltage based on the constant current.

2. The substrate according to claim 1, wherein said driving voltage generating circuit includes an n-type field effect transistor with a gate to which the constant current generated by the constant current source is supplied.

3. The substrate according to claim 2, wherein the n-type field effect transistor has a drain to which the first voltage is applied, and a source from which the second voltage is output to the driving voltage converter circuit.

4. The substrate according to claim 3, wherein
the source is connected to a resistor, and a connection point between the source and the resistor serves as an output terminal to apply the voltage to the driving voltage converter circuit.

5. The substrate according to claim 1, wherein said driving voltage generating circuit is supplied a voltage for driving the constant current source from a power supply for driving the logical circuit.

6. The substrate according to claim 1, wherein the element substrate is a substrate for an inkjet printhead.

7. A printhead comprising an element substrate which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements,
said element substrate comprising:
a driving voltage generating circuit which generates, on the basis of the first voltage, the second voltage to drive the driving voltage converter circuit,
wherein said driving voltage generating circuit has a constant current source for generating a constant current based on the first voltage and generates the second voltage based on the constant current.

8. A head cartridge having an ink tank containing ink and a printhead comprising an element substrate which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements,
said element substrate comprising:
a driving voltage generating circuit which generates, on the basis of the first voltage, the second voltage to drive the driving voltage converter circuit,
wherein said driving voltage generating circuit has a constant current source for generating a constant current based on the first voltage and generates the second voltage based on the constant current.

9. A printing apparatus having a printhead comprising an element substrate which includes a plurality of printing elements to which a first voltage is applied, a plurality of driving elements which drive the plurality of printing elements, a logical circuit which outputs a driving signal to control the plurality of driving elements, and a driving voltage converter circuit which converts a voltage of the driving signal output from the logical circuit into a second voltage lower than the first voltage and outputs the second voltage to the plurality of driving elements,
said element substrate comprising:
a driving voltage generating circuit which generates, on the basis of the first voltage, the second voltage to drive the driving voltage converter circuit,
wherein said driving voltage generating circuit has a constant current source for generating a constant current based on the first voltage and generates the second voltage based on the constant current.
